(19) United States
(12) Patent Application Publication
(10) Pub. No.: US 2021/0179385 A1
(43) Pub. Date: Jun. 17, 2021

(54) METHOD OF PRIORITIZING PASSENGER TRAVEL IN AN ELEVATOR

(71) Applicant: thyssenkrupp Elevator Innovation and Operations GmbH, Essen (DE)

(72) Inventors: Michael Calisi, Boca Raton, FL (US); Nejib Masghouni, Alpharetta, GA (US); Andrew Evert, Atlanta, GA (US)

(73) Assignee: thyssenkrupp Elevator Innovation and Operations GmbH, Essen (DE)

(21) Appl. No.: 17/247,332

(22) Filed: Dec. 7, 2020

(30) Foreign Application Priority Data
Dec. 12, 2019 (EP) 19215480.5

(51) Int. Cl. B66B 1/24; G06Q 50/26; G07C 9/37; G06Q 10/06; B66B 1/28; B66B 5/00; G06K 9/00

(52) U.S. Cl. CPC B66B 1/2408; G06Q 50/265; G07C 9/37; G06Q 10/06312; G06Q 50/163; B66B 5/0012; G06K 9/00362; G06Q 2240/00; B66B 1/28

(57) ABSTRACT

A method of prioritizing passenger travel in an elevator to one or more destination floors in a building, wherein the number of floors comprise at least high security floors and low security floors, includes identifying a security level of each passenger, verifying the security clearance level assigned to each passenger, generating a prioritized sequence to specify an order in which the cabin will travel to the destination floors based on the security clearance level, and executing a travel plan for the elevator cab causing the elevator cab to move to the relevant destination floors in the order specified in the prioritized sequence.

### CROSS-REFERENCE TO RELATED APPLICATIONS

This application claims priority to European Patent Application Serial No. EP19215480.5 filed Dec. 12, 2019, the entire contents of which is hereby incorporated by reference herein.

### FIELD

This disclosure relates to a method of improving elevator and building security. In particular, the method refers to a method of prioritizing passenger travel to one or more serviced floors in a building, wherein the number of floors comprise at least high security floors and low security floors.

### BACKGROUND

Modern day elevators are becoming more and more intelligent. There are various systems used for example to identify and count the number of passengers; to detect the presence of a passenger; to make the elevator more passenger friendly, be it via smart technology and touchscreens. Due to the ever-increasing population and the constant expansion of cities, the need for tall buildings is a constant in the ever-changing urbanization of today's world. The elevators needed to service these buildings are thus required to be more robust and more intelligent than ever before in order to accommodate the busy people of today's world.

US20160311646 A1 describes a system capable of recognizing the elevator passenger's face which then sends a signal to the elevator control system to move the elevator car to the elevator passenger's authorized floor destination. When more than one passenger is present in the elevator however, there is no way of preventing a passenger from leaving the elevator at a floor for which they have no authorization. Thus, the security of the building and the people therein can be compromised.

There is therefore a need to address this security concern and provide a means of preventing a person in an elevator cabin from reaching/accessing a floor of a building that the person is not authorized to access.

### BRIEF DESCRIPTION OF THE DRAWINGS

The present invention is described in detail below with reference to the attached drawing figures, wherein:

FIG. 1a is a schematic view of an embodiment of a building of the present disclosure having a plurality of different floors that are serviced by an elevator, the floors being grouped by the various levels of security clearance required to gain access to such floors within each group;

FIG. 1b is a schematic view of the building of FIG. 1a showing a number of elevator cabins in an elevator shaft servicing the various floors;

FIG. 2a is a schematic view of a number of passengers standing in an elevator cabin;

FIG. 2b is a schematic view of the passengers in the elevator cabin of FIG. 2, in which each passenger is identified by their respective security clearances;

FIG. 3a is a schematic view of a building of the present disclosure having a number of floors serviced by an elevator (elevator not shown);

FIG. 3b is a schematic view of a number of passengers standing in an elevator cabin, in which each passenger has a different security clearance;

FIG. 4a is a schematic view of a group of passengers waiting in an elevator lobby to board and travel in an elevator, wherein the security clearance of each passenger varies throughout the group;

FIG. 4b is a schematic view of a group of passengers waiting in an elevator lobby to board and travel in an elevator, wherein the security clearance of each passenger varies throughout the group.

### DETAILED DESCRIPTION

Although certain example methods and apparatus have been described herein, the scope of coverage of this patent is not limited thereto. On the contrary, this patent covers all methods, apparatus, and articles of manufacture fairly falling within the scope of the appended claims either literally or under the doctrine of equivalents. Moreover, those having ordinary skill in the art will understand that reciting “a” element or “an” element in the appended claims does not restrict those claims to articles, apparatuses, systems, methods, or the like having only one of that element, even where other elements in the same claim or different claims are preceded by “at least one” or similar language. Similarly, it should be understood that the steps of any method claims need not necessarily be performed in the order in which they are recited, unless so required by the context of the claims. In addition, all references to one skilled in the art shall be understood to refer to one having ordinary skill in the art.

The present disclosure generally relates to a method of prioritizing passenger travel to one or more serviced floors in a building via an elevator system having an elevator cabin, wherein the number of floors comprise at least high security floors (including top security floors), medium security floors, and low security floors, wherein low security floors can include general public floors.

In an embodiment of the present disclosure, any one or more of businesses, hotels, apartments, penthouse suites, secure areas, and/or any other similarly used physical spaces can be located on one or more floors of the building. Preferably each floor has its own assigned security status. In certain cases, some floors can have the same security status as other floors. For example, to permit employees of a business operating on multiple floors of a building to travel between the floors uninterrupted, the business can have the same level of security clearance needed to access its floors assigned to all of the floors on which it operates. It is also possible that, for example, within one business various employees may be assigned different levels of security clearance, in which case, various security statuses can be assigned to one or more floor(s) as desired.

An embodiment of a method of the present disclosure can include the step of identifying a passenger, wherein the passenger has a security clearance assigned to him that permits the passenger to gain access to at least one floor of the building. Alternatively phrased, the method may include the step of identifying each passenger to be transported in the elevator cabin to one or more destination floors, wherein at least some of the destination floors are secure destination floors. It is possible for a passenger to have more than one security clearance, or level of security clearance, which would enable the passenger to gain access to different floors requiring different security clearances, or levels of security clearance. In one embodiment, if a passenger does not have any security clearance, the passenger is only permitted to travel to general public floors. Identification of a passenger and/or the passenger's assigned level of security clearance is preferably carried out via an identification device.

The method also may include a step of detecting, recognizing, and/or verifying, for each identified passenger, any security clearance level assigned to the passenger that will grant access to at least one of the secure destination floors. This is preferably carried out by establishing a co-operation between the identification device and a control unit of the elevator system. The control unit may be programmed with software that allows it to identify, and recognize/detect/verify the security clearance, or level of security clearance, granted or assigned to any given passenger. This data can then be matched to a database of stored security clearances.

The method may further include a step of assigning the security clearance to the relevant floor.

In a method of the present disclosure, when more than one passenger is present in an elevator cabin, or in some embodiments, waiting at an elevator lobby to travel together on the elevator, the method may further include the control unit generating a prioritized sequence of the relevant destination floors, which is a prioritized order in which the elevator cabin will travel to the relevant destination floors to which each passenger in the elevator cab intends to travel, according to or based on the verified security clearance levels assigned or granted to each passenger. Preferably the prioritizing sequence is the application of an algorithm to the data already gathered by the identification device and the control unit.

The method then further includes executing a travel plan or route for the elevator cabin, in order to move the elevator cabin to the relevant destination floor(s) according to, or in the order specified in, the generated priority sequence. In one embodiment, the travel plan preferably includes moving the elevator cabin to the destination floors in order of ascending levels of security clearance needed to access the relevant floors (i.e. first traveling to any low security/general public use floors, before moving next to floors that require a higher security clearance to gain access). If for example, the top security floors are located on the lower floors of a building, the executed travel plan will preferably direct the elevator cabin to first bypass these floors and instead travel to floors having lower security clearance access requirements.

This method advantageously provides an elevator having improved intelligence, and thereby improves personal safety of people in a building as it prevents unauthorized persons from arriving at and entering floors of a building for which they have no security clearance.

In another embodiment of the present disclosure, the method can be carried out when passengers are located inside an elevator cabin.

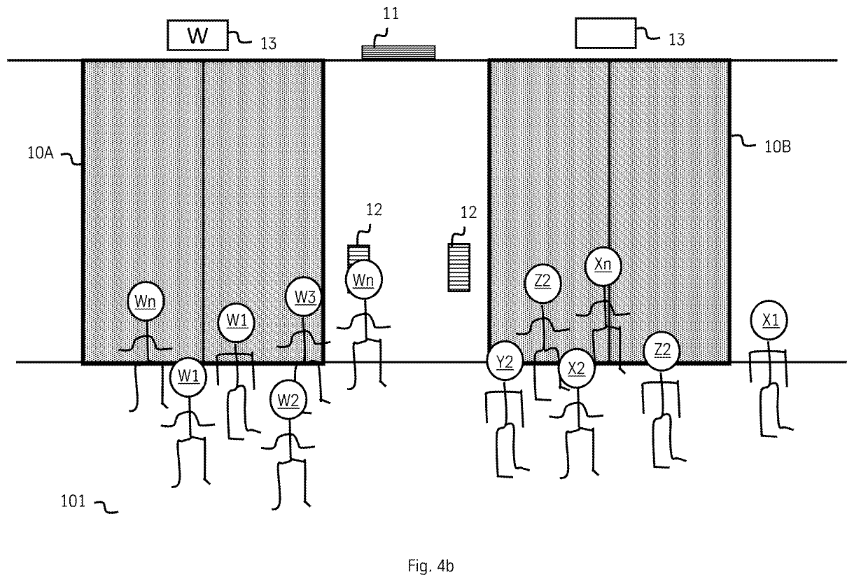

In an alternate embodiment, the method can be performed when passengers are located outside an elevator cabin, for example, while waiting for an elevator in a waiting area or landing area, or lobby area. This advantageously saves time for passengers since those passengers with one particular security clearance can enter one particular elevator cabin and arrive at their respective destination floors without having to wait until other passengers, having different security clearances, are first transferred to their respective floors. This is explained in more detail in the figure description of FIGS. 4a and 4b.

In an alternate embodiment, the method can also be carried out when passengers are located both inside and outside an elevator cabin. For example, the method can be performed as passengers wait in a lobby area of a building to enter an elevator cabin, and then it can be performed at least once again after all passengers are inside the cabin and before it begins to travel. This advantageously provides a two-tier security mechanism, which thus improves the overall security within a building. This also improves passenger satisfaction and can help extend the lifetime of the elevator as it avoids superfluous travel.

In another embodiment of the invention, the method is performed by computer readable and executable software code programmed within a control unit of the elevator, or within an external piece of hardware that is connected to the control unit of the elevator. The software code may include one or more algorithm(s) configured to determine how best to move the elevator cabin. The software code can be downloaded to the control unit, or take the form of an external piece of hardware that is connected to the control unit. The connection between the external piece of hardware and the control unit can be via physical communication connection means, such as through the use of a wired cable connection (e.g. wired ethernet, etc.), or wireless communication (e.g. wi-fi, Bluetooth, the cloud, etc.).

In one embodiment of the invention, identification of a passenger is performed using an identification device that may comprise one or more of an ID registration system, an image capturing device, or any other biometric identification system that permits the identification device to uniquely identify any individual passenger and their level of associated security clearance that they have been granted or assigned. This advantageously provides a method that can be implemented with an elevator system having an existing intelligent recognition system. The ID registration system can, for example, read a passenger's ID card that is required to use the elevator or gain entry into a building. The ID card may be on the person of the passenger and need not necessarily be visibly shown or seen to activate the elevator, or when entering the elevator (e.g. the ID card can be located in a passenger's pants, jacket pocket, backpack, etc. and still be read by the ID registration system). An image capturing device can include, for example, a camera or any other device that can capture and use facial recognition or other visual means to identify a person.

In one embodiment of the present disclosure, the various floors in a building can have at least one of the following levels of security clearance: top security; high security; medium security; low security; no security.

In an embodiment of the present disclosure, each floor serviced by the elevator cabin has its own unique level of security clearance assigned to it, which level of security clearance a passenger must also be granted in order to gain access to the floor. In such embodiment, one or more floor(s) may have the same level of assigned security clearance. This advantageously ensures that, for example, an employee of a business occupying more than one floor of a building is able to freely travel between floors occupied by the business.

In an embodiment of the present disclosure, the elevator cabin preferably travels to floors having the same security clearance in ascending or descending order. For example, there may be three floors that are each assigned a security clearance level of X2 (e.g., floors X2-1, X2-2, X2-3), and require a passenger to be granted/assigned the same level of security clearance in order to gain access to those floors. If a passenger enters the cabin at floor X2-2 and the desired floor is X2-3, the elevator will stop at the desired floor X2-3 before continuing with the prioritized travel route. Likewise, if the desired floor is X2-1, the elevator will stop at the desired floor X2-1 before continuing with the prioritized travel route. This applies, even when the elevator has to change travel direction from upwards to downwards.

In an embodiment of the present disclosure, when a passenger without any security clearance enters the elevator, the method comprises the additional steps of identifying the passenger, wherein the passenger has no security clearance, and optionally generating a re-prioritized sequence of the relevant destination floors. For example, in one embodiment the re-prioritized sequence may cause the order in which the elevator cabin travels to the destination floors that are to be serviced to be altered, so that the next destination floor to be serviced by the elevator is a floor with low or zero security level access requirements, rather than a floor with higher security level access requirements.

In an embodiment of the present disclosure, the method steps are initiated/practiced/implemented each time at least one new passenger enters the elevator cabin. This advantageously ensures that a high degree of security is maintained throughout the operation and service life of the elevator.

The method of the present disclosure can be practiced in nearly any building, especially, for example, one that requires a security system, or is a high-security building. This advantageously provides a building with improved security.

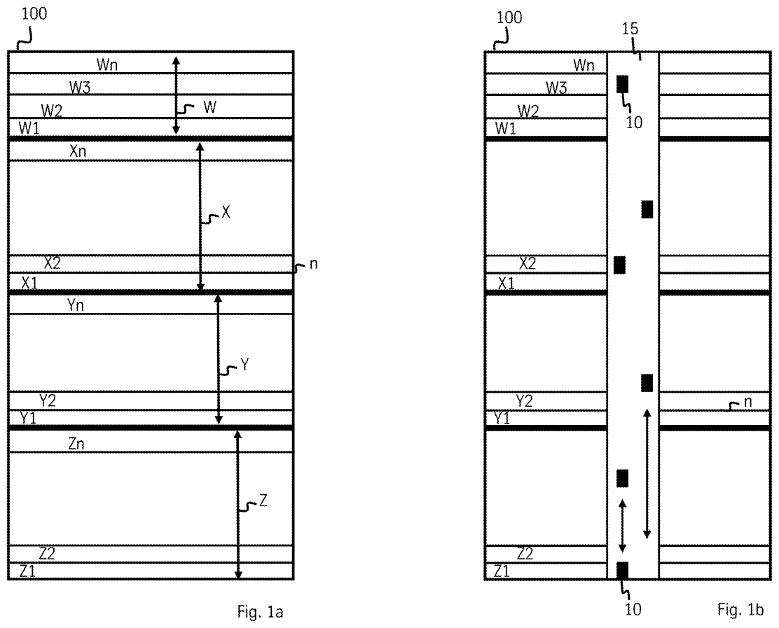

Referring now to the drawing figures, FIG. 1a shows a schematic representation of a building 100 having a number of floors n, wherein the floors are each divided or grouped according to their security clearance requirements. In other words, the floors, including some secure floors requiring a security clearance to gain access thereto, are grouped according to the level of security clearance a passenger is required to have or to be granted/assigned, in order to gain access to such floors.

The low security floors (or in some embodiments, no security floors), which are floors requiring an elevator passenger to have a low level of security clearance (or no security clearance) to gain access thereto, including floors open to the general public, are assigned the security clearance level of Z. This means that, in some embodiments, a passenger need not have any security clearance assigned, or in other embodiments, must have or be assigned, the same low Z level of security clearance (or perhaps in some alternate embodiments, a higher level of security clearance than Z) in order to be granted access to such low security floors. The first two floors Z1, Z2, and the nth Z floor, Zn, are shown.

The medium security floors, which are secure floors requiring an elevator passenger to have a medium level of security clearance to gain access thereto, are assigned the security clearance level of Y. This means that a passenger must have, or be assigned, the same Y level of security clearance (or perhaps in some alternate embodiments, a higher level of security clearance than Y) in order to be granted access to such medium security floors. It also means that those passengers with a lower level of security clearance (e.g. the Z level of security clearance), will not be able to gain access to such medium security floors. The first two floors Y1, Y2, and the nth Y floor, Yn, are shown.

The high security floors, which are secure floors requiring a high level of security clearance to gain access thereto, are assigned the security clearance level of X. This means that a passenger must have, or be assigned, the same X level of security clearance (or perhaps in some alternate embodiments, a higher level of security clearance than X) in order to be granted access to such high security floors. It also means that those passengers with a lower level of security clearance (e.g. the Z or Y level of security clearance), will not be able to gain access to such medium security floors. The first two floors X1, X2 and the nth X floor Xn are shown.

The top security floors, which are secure floors requiring a top level of security clearance to gain access thereto, are assigned the security clearance level of W. This means that a passenger must have, or be assigned, the same W level of security clearance (or perhaps in some alternate embodiments, a higher level of security clearance than W) in order to be granted access to such top security floors. It also means that those passengers with a lower level of security clearance (e.g. the Z, Y, or X level of security clearance), will not be able to gain access to such top security floors. In this particular example shown in FIG. 1a, the top security floors are shown in the following order W1, W2, W3, Wn, wherein floor W1 requires a lower level of security clearance to gain access to it than floor Wn. It is also possible that all top security floors W1-Wn have the same top security clearance level (e.g. the same level of security clearance as floor W2).

In this particular example shown in FIG. 1a, the floors within each security clearance level (i.e. security clearance levels W, X, Y, Z) have an ascending security clearance level assigned to them. In other words, floor X2 requires a passenger to have a higher security clearance level to gain access to it than floor X1, and floor Y2 requires a passenger to have a higher security clearance level than Y1 to gain access to it. For the low security floors, the bottom two floors Z1, Z2 are open to the general public and do not therefore require any security clearance to access them, however floor Zn does require a security clearance.

FIG. 1b shows the building 100, as shown in FIG. 1a, comprising an elevator system having a number of elevator cabins 10 in the elevator shaft 15 servicing the various floors n of the building. In this particular example, several elevator cabins 10 are shown in the elevator shaft 15, however, any number of cabins 10 can be used, as can any number of elevator shafts 15 comprising any number of cabins 10.

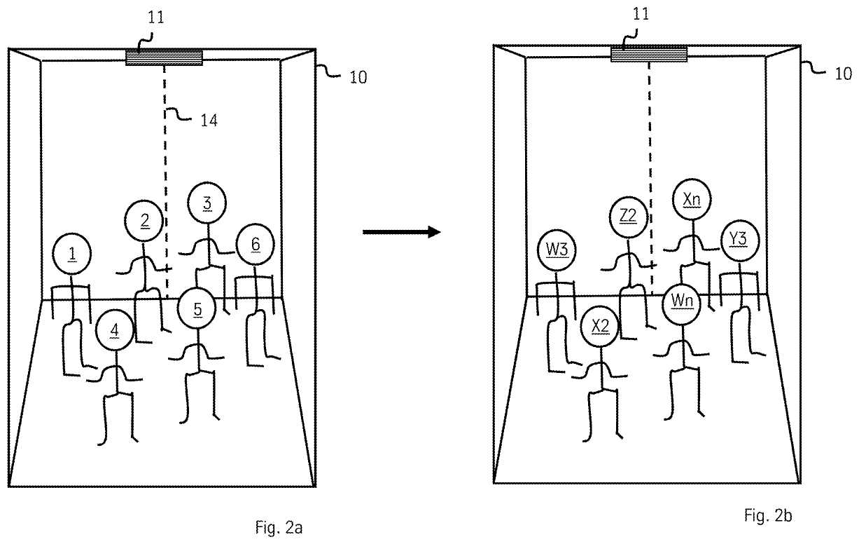

FIG. 2a shows an elevator cabin 10, wherein a number of passengers 1, 2, 3, 4, 5, 6 are standing. The elevator doors 14 are closed. An identification device 11 is located within the cabin 10. This device 11 identifies the passengers 1, 2, 3, 4, 5, 6, and, through co-operation with a control unit of the elevator (not shown), wherein said control unit is adapted with software that allows it to identify and recognize/verify the security clearance level assigned to a passenger, is able to assign the security clearance W, X, Y, Z of each passenger 1, 2, 3, 4, 5, 6, to the relevant floor n. It is possible for a passenger to have more than one security clearance, however in the examples provided, each passenger has only one security clearance.

FIG. 2b shows how the passengers 1, 2, 3, 4, 5, 6 of FIG. 2a are identified via their respective security clearances W, X, Y, Z. Each passenger is travelling to a different destination floor in which each destination floor is a secure floor that requires a different security clearance level to gain access thereto (e.g. W3, Z2, Xn, X2, Wn, Y3). By implementing the method according to the invention, a passenger having an assigned security clearance level to access floor X2 will not be able to travel to floor W2. Likewise the passenger having an assigned security clearance level to access floor W2 will not be able to travel to floor Wn since the control unit of the elevator system has prioritized its travel route according to the security clearances of the passengers located within the cabin 10. If the passenger having the security clearance level required to access floor Wn is first to enter the cabin 10 and first to input their destination floor, the control unit will wait until all destination floors by all passengers have been input/entered, before prioritizing the order (i.e. generating a prioritized sequence) in which the cabin will travel to the various destination floors accordingly, and then preparing a travel plan or route for the elevator cabin 10 that follows this prioritized order/sequence. As such, the passenger with the highest assigned security clearance level will be the last to depart the elevator cabin 10 at his destination floor and the passenger with no security clearance, or the lowest level of security clearance, will be the first to depart the elevator cabin 10 at his destination floor. When the elevator cabin 10 is in the middle of an executed travel plan/route and a new passenger enters the elevator cabin 10 at a different floor than the floor(s) at which the other passengers in the elevator cabin 10 previously entered the elevator cabin, the method is re-performed to identify any new security clearance level assigned to the new passenger and re-prioritize the order in which the elevator cabin will travel to the destination floors accordingly. This reprioritized order or sequence is in turn used to generate a new or updated travel plan/route. Since the top security floors occupy the top floors of the building 100 and the low security floors occupy the lowest floors of the building, with the middle and high security floors following in ascending order, the travel route of the elevator is relatively straightforward.

So, in the example of the embodiment shown in FIG. 2b, the order of passenger disembarkation for passengers 1-6 that respectively have associated required security clearances to access/travel to destination floors W3, Z2, Xn, X2, Wn, Y3, is as follows:

a) Z2, no security clearance is required for this floor, so the elevator 10 will stop first here;

b) Y3, higher security clearance than Z2, but lower than the X floors;

c) X2;

d) Xn, since Xn is higher than X2;

e) W3;

f) Wn, this is the highest floor in the building 100 and also requires the highest security clearance.

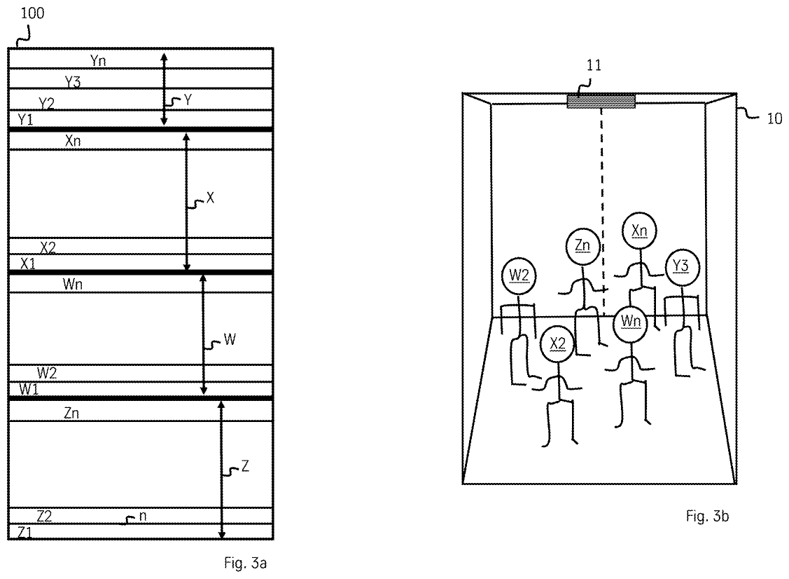

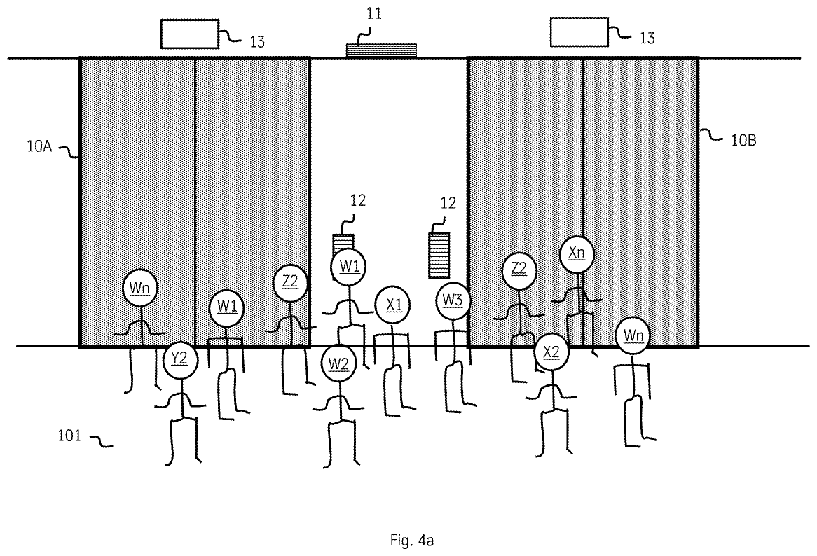

FIG. 3a shows a building 100 wherein the security clearances of the floors are not in ascending order, i.e., the top security floors W are located just above the low security floors, whilst the medium security floors Y occupy the uppermost floors of the building 100. The passengers in the elevator cabin 10 of FIG. 3b all have different security clearances. The identification device 11 located in the elevator cabin 10 identifies the passengers. By applying the method of the invention, the control unit (not shown), equipped with the required software, matches each identified passenger with their respective security clearance, assigns the clearances to the relevant floors W, X, Y, Z of the building 100, generates a prioritized sequence of destination floors defining the order in which the elevator cabin will travel to the destination floors, and executes the travel route for the elevator cabin based on the prioritized sequence accordingly. Should a passenger enter the elevator cabin 10 at a different floor during the original travel route of the elevator cabin 10, the method is re-performed to assign any new security clearance, generate a re-prioritized sequence of destination floors, and execute an updated travel route accordingly.

Since the top security and high security floors occupy the middle floors of the building 100 and the low security and medium security floors respectively occupy the lowest and highest floors of the building, the travel route of the elevator must change accordingly.

The order of passenger disembarkation for the embodiment shown in FIGS. 3a and 3b, is as follows:

a) Zn, out of all the passengers in the cabin 10, this floor has the lowest security clearance, so the elevator 10 will stop first here;

b) Y3, higher security clearance than Zn, but lower than the remaining X and W floors, thus the elevator will travel from the bottom of the building to the top of the building;

c) X2;

d) Xn, since Xn is higher than X2, thus the elevator 10 will travel downwards when serving both floors respectively;

e) W2;

f) Wn, this is the floor requiring the highest security clearance in the building 100. The elevator will continue to travel downwards to floor W2 after having serviced the X floors, and then travel upwards to service floor Wn.

In another embodiment of the invention, the method can also be carried out before a passenger enters the elevator cabin. This is shown in FIGS. 4a and 4b. An identification device 11 is positioned so that it covers a waiting area 101 where passengers having various assigned security clearance levels W, X, Y, Z are waiting to board one of elevators 10A or 10B. The identification device 11 identifies the passengers through co-operation with a control unit. The control unit is adapted with software that allows it to identify and recognize the security clearance level assigned to a passenger and assign the security clearance W, X, Y, Z of each passenger to the relevant floor n. When one particular security clearance level is more prevalent, as shown in FIG. 4a with the security clearance level for the destination floors grouped in security level W, the method of the present disclosure provides for the control unit to assign a particular elevator 10A, 10B to service a particular destination floor n, or number of destination floors n requiring a particular security clearance level W, X, Y, Z to gain access thereto. In this example, there are more passengers assigned a security clearance level W. The control unit assigns the elevator 10A to service the floors having a W security clearance. This can be made known to waiting passengers by showing a “W” on the floor designator 13, or via an audio announcement, or via any other means to alert passengers to the destination of a particular elevator, in this case, elevator 10A. Once aware of this information, the passengers can re-position themselves before the correct elevator and wait for its arrival, shown in FIG. 4b.

When passengers traveling to secure destination floors requiring a security clearance level of W have entered the cabin of elevator 10A, the method according to the present disclosure can be performed once again inside the cabin 10A in order to ensure that the various security clearance levels required to access destination floors grouped within in security level W are respected. Therefore, the passengers going to secure destination floor Wn will arrive at their destination last, and the passengers going to secure destination floor W1 will arrive at their destination first, regardless of the order of destination inputs by the passengers. This ultimately saves time for passengers since those passengers assigned a security clearance W are able to arrive at their respective destination floors without having to wait until the other passengers having security clearance levels of X, Y, Z are transferred to their respective destination floors. This improves passenger satisfaction and can also help extend the lifetime of the elevator as it avoids superfluous travel.

In an embodiment of the invention, not reflected in the figures, the method can be applied to an elevator that is already in transit when a passenger at a floor waiting area presses the elevator call button. An identification device 11 located to cover a waiting area 101 can identify said passenger, and through the control unit, assign the security clearance thereto. If that passenger has a clearance that matches the prioritized travel route of the elevator, the elevator can stop at the selected floor to admit the passenger. If the passenger has a security clearance that would require the generation of a re-prioritized sequence of destination floors, and execute an updated travel route, then the elevator can optionally stop its current travel plan/route, generate the re-prioritized sequence to include the new passenger's destination floor, and execute an updated travel plan.

### LIST OF REFERENCE NUMERALS/CHARACTERS IN THE DRAWINGS

100 building

101 waiting area

1-6 passenger

10 elevator/cabin

10A, 10B elevator

11 identification device

12 call button

13 floor designator

14 elevator doors

15 elevator shaft

n floor

Wn top security floors

Xn high security floors

Yn medium security floors

Zn low/zero security floors

W1-W4 top security floors

X1-X2 high security floors

Y1-Y2 medium security floors

Z1, Z2 low/zero security floors

What is claimed is:

1. A method of prioritizing passenger travel to one or more floors of a building via an elevator system having an elevator cabin, wherein the floors of the building include at least a plurality of secure floors designated as one or more of high security floors and/or low security floors, the method comprising:
identifying each passenger to be transported in the elevator cabin to one or more destination floors, wherein at least some of the destination floors are secure destination floors;
verifying, for each identified passenger, any security clearance level assigned to the passenger that will grant access to at least one of the secure destination floors;
generating a prioritized sequence of the destination floors to specify an order in which the cabin will travel to the destination floors, based on the verified security clearance levels of each of the passengers; and
executing a travel plan for the elevator cabin, the travel plan causing the elevator to move to the relevant destination floors in the order specified in the generated prioritized sequence.

2. The method of claim 1, wherein the identifying and verifying steps are performed inside the elevator cabin, outside the elevator cabin, or both inside and outside the elevator cabin.

3. The method of claim 1, wherein each of the identifying, verifying, generating, and executing steps is performed by computer executable code stored in a control unit of the elevator, or in an external piece of hardware connected to the control unit of the elevator.

4. The method of claim 1, wherein the identifying step is performed by an identification device that includes one or more of an ID registration device, an image capturing device, or a biometric identification device to identify a passenger and their assigned security clearance level.

5. The method of claim 1, wherein each secure destination floor serviced by the elevator cabin requires a unique level of security clearance to permit access thereto and wherein two or more floors may require the same level of security clearance to permit access thereto.

6. The method of claim 1, further comprising:
moving the elevator cabin to destination floors requiring the same level of security clearance, in either of an ascending or descending order.

7. The method of claim 1, further comprising:
identifying a new passenger entering the elevator cabin;
verifying the new passenger has either no security clearance assigned, or a different security clearance level assigned than the other passengers already in the elevator cabin; and
generating a re-prioritized sequence of the relevant destination floors.

8. The method of claim 1, further comprising repeating each of the identifying, verifying, generating, and executing steps each time at least one new passenger enters the elevator cabin.
